(19) United States
(12) Patent Application Publication
(10) Pub. No.: US 2025/0390007 A1
(43) Pub. Date: Dec. 25, 2025

(54) QUICK-RELEASE PLATE MOUNTING BASE AND AUXILIARY SHOOTING DEVICE

(71) Applicant: TILTA INC., Burbank, CA (US)

(72) Inventors: Weihan SHE, Shenzhen (CN); Wenping ZENG, Shenzhen (CN); Kefeng ZHOU, Shenzhen (CN)

(21) Appl. No.: 19/237,450

(22) Filed: Jun. 13, 2025

(30) Foreign Application Priority Data
Jun. 21, 2024 (CN) 2024214395250

(51) Int. Cl. G03B 17/56; F16M 11/04

(52) U.S. Cl. CPC G03B 17/561; F16M 11/041

(57) ABSTRACT

A quick-release plate mounting base and an auxiliary shooting device are disclosed. The quick-release plate mounting base includes: a base body featuring a first clamping groove and a second clamping groove; a first locking member, movably disposed on the base body, capable of assuming a locking state to secure a first type of quick-release plate within the first clamping groove, and an unlocking state to release it; a second locking member, also movably arranged on the base body, capable of assuming a locking state to secure a second type of quick-release plate within the second clamping groove, and an unlocking state to release it; a driving mechanism, movably mounted on the base body and interconnected with both the first and the second locking members, designed to drive these locking members to transition between their respective locking and unlocking states.

### CROSS-REFERENCE TO RELATED APPLICATIONS

The present application for patent claims priority to and the benefit of pending Chinese Application No. 2024214395250, filed Jun. 21, 2024, and hereby expressly incorporated by reference herein as if fully set forth below in its entirety and for all applicable purposes.

### TECHNICAL FIELD

This disclosure pertains to the technical field of auxiliary shooting equipment, specifically to a mounting base and an auxiliary shooting device.

### INTRODUCTION

In the field of photography and videography, tripods are essential auxiliary equipment, playing a crucial role in enabling photographers to achieve stable shooting results. A typical tripod includes a tripod body and a quick-release plate. Shooting equipment can be mounted onto the quick-release plate, which is then secured onto the quick-release plate mounting base on the tripod body. The quick-release plate and its mounting base serve as a bridge for the detachable installation of shooting equipment onto the tripod body. However, in the current photography equipment market, due to the diverse specifications of cameras and accessories from various brands and models, there are multiple standards for quick-release plates, such as the Manfrotto quick-release plate and the Arca-Swiss quick-release plate.

This diversity in quick-release plate standards presents significant inconveniences for photographers. When photographers need to switch to quick-release plates of different brands or models, they must first replace the matching quick-release plate mounting base, which adds to the inconvenience of their shooting work.

### BRIEF SUMMARY

This disclosure presents a new quick-release plate mounting base and an auxiliary shooting device to address the issue where photographers have to replace the matching mounting base when switching to quick-release plates of different brands or models.

According to some aspects, an embodiment provides a quick-release plate mounting base, including:
a base body, wherein the base body is provided with a first clamping groove and a second clamping groove, with the extension direction of the first clamping groove intersecting that of the second clamping groove; the first clamping groove is configured for installing a first type of quick-release plate, and the second clamping groove is configured for installing a second type of quick-release plate;
a first locking member, which is movably arranged on the base body; the first locking member has a locking state for securing the first type of quick-release plate within the first clamping groove and an unlocking state for releasing the first type of quick-release plate;
a second locking member, which is movably arranged on the base body; the second locking member has a locking state for securing the second type of quick-release plate within the second clamping groove and an unlocking state for releasing the second type of quick-release plate;
a driving mechanism, which is movably arranged on the base body and is connected to the first locking member and the second locking member; the driving mechanism is used to drive the first locking member and the second locking member to switch between their corresponding locked and unlocking states.

### BRIEF DESCRIPTION OF THE DRAWINGS

FIG. 1 is a diagram illustrating a first state of a quick-release plate mounting base according to some aspects of the disclosure.

FIG. 2 is a diagram illustrating a second state of the quick-release plate mounting base according to some aspects of the disclosure.

FIG. 3 is a diagram illustrating the quick-release plate mounting base installed with a first type of quick-release plate according to some aspects of the disclosure.

FIG. 4 is diagram illustrating a side view of the quick-release plate mounting base installed with a first type of quick-release plate according to some aspects of the disclosure.

FIG. 5 is a diagram illustrating the quick-release plate mounting base installed with a second type of quick-release plate according to some aspects of the disclosure.

FIG. 6 is a diagram illustrating an exploded view of the quick-release plate mounting base according to some aspects of the disclosure.

FIG. 7 is a diagram illustrating a driving mechanism in a locking state according to some aspects of the disclosure.

FIG. 8 is a diagram illustrating the driving mechanism in an unlocked state according to some aspects of the disclosure.

FIG. 9 is a diagram illustrating an internal structure of the quick-release plate mounting base according to some aspects of the disclosure.

FIG. 10 is a diagram of an engagement component and a locking component according to some aspects of the disclosure.

FIG. 11 is diagram illustrating an exploded diagram of the quick-release plate mounting base according to some aspects of the disclosure.

FIG. 12 is diagram illustrating an exploded view of the locking component and a transmission component according to some aspects of the disclosure.

FIG. 13 is diagram illustrating an auxiliary shooting device according to some aspects of the disclosure.

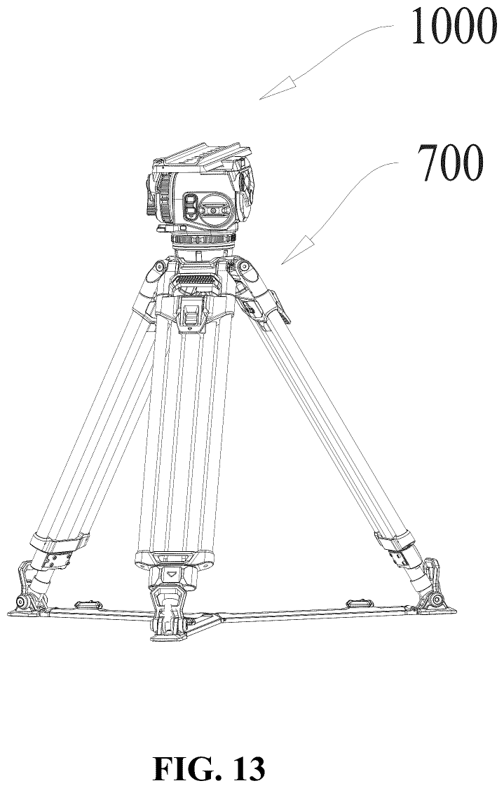

### REFERENCE NUMBERS

1000. auxiliary shooting device
100. base body; 110. upper housing; 111. first clamping groove; 1111. clamping member; 112. second clamping groove; 1121. limiting sliding groove; 113. first mounting opening; 114. second mounting opening; 115. fixed protrusion; 120. lower housing; 130. adjusting hole; 140. second anti-disengagement protrusion; 150. adjusting screw;
200. first locking member; 210. pressing part; 220. clamping part; 221. limiting protrusion; 222. boss; 230. first spring;
300. second locking member; 310. locking main body part; 320. locking lifting part; 321. pushed inclined surface; 330. second spring;
400. driving mechanism; 410. engagement component; 411. resisting member; 4111. resisting part; 4112. groove; 4113. sliding part; 4114. limiting part; 412. unlocking member; 4121. first part; 4122. second part; 4123. third part; 4124. first auxiliary spring; 4125. first anti-disengagement protrusion; 413. clamping spring; 420. locking component; 421. locking actuator; 4211. locking plate; 42111. avoiding cavity; 42112. second auxiliary spring; 42113. fitting cavity; 42114. second driving inclined surface; 4212. locking part; 42121. avoiding groove; 4213. protruding block; 422. locking operator; 430. transmission component; 431. locking trigger; 4311. trigger inclined surface; 432. linkage member; 4321. linkage part; 4313. fitting protrusion; 4314. first driving inclined surface; 4322. linkage rod; 43221. limiting end;
500. first type of quick-release plate;
600. second type of quick-release plate;
700. tripod main body.

### DETAILED DESCRIPTION

Aspects of the present disclosure are further elaborated upon through detailed description in conjunction with the drawings. Similar components across different aspects may be associated with similar component labels. In the following aspects, numerous detailed descriptions are provided to facilitate a better understanding of the present disclosure. However, those skilled in the art can readily recognize that some features can be omitted in various scenarios or replaced with other components, materials, or methods. In some instances, certain operations related to the present disclosure may not be shown or described in the specification to avoid overwhelming the core aspects of the present disclosure with excessive descriptions. Those skilled in the art can fully comprehend the related operations based on the description herein and general technical knowledge in the field.

Additionally, the features, operations, or characteristics described in the specification may be combined in any suitable manner for various aspects. The sequence of operational steps involved in each example may also be rearranged or adjusted in a manner apparent to those skilled in the art. Therefore, the specification and accompanying drawings are merely for the purpose of clearly describing a particular example and do not imply that the described components and/or sequence are mandatory. Unless otherwise specified, a given sequence of steps must be followed.

The numbering of components, parts, and/or elements in this document, such as “first,” “second,” etc., is solely for the purpose of distinguishing the described objects and does not carry any sequential or technical significance. Unless specified otherwise, the terms “connected” and “coupled” as used in this disclosure encompass both direct and indirect connections (or couplings).

The quick-release plate mounting base of this disclosure provides mounting positions for a first type of quick-release plate 500 and a second type of quick-release plate 600 by providing a first clamping groove 111 and a second clamping groove 112 on the base body 100. By incorporating a first locking member 200, a second locking member 300, and a driving mechanism 400, and adjusting the driving mechanism 400 allows the first locking member 200 to be switched to a locking state to secure the first type of quick-release plate 500 and the second locking member 300 to be switched to a locking state to secure the second type of quick-release plate 600. When photographers need to replace shooting equipment compatible with different types of quick-release plates, such as switching between the first type of quick-release plate 500 and the second type of quick-release plate 600, they may install it at the corresponding position without replacing the mounting base.

In the present disclosure, the shooting equipment mentioned can be a camera or a camera kit with accessories such as a full cage.

Currently, quick-release plates (such as Manfrotto quick-release plates and Arca-Swiss quick-release plates) are commonly used for rapid clamping of shooting equipment to a mounting base. Therefore, the following disclosure will use these types of quick-release plates as examples to illustrate various aspects of the present disclosure. To facilitate the understanding of this solution, the first type of quick-release plate 500 and the second type of quick-release plate 600 can be considered as one of the Manfrotto quick-release plate and the Arca-Swiss quick-release plate, respectively. However, this is just one example of the first type of quick-release plate 500 and the second type of quick-release plate 600 mentioned below and does not limit them.

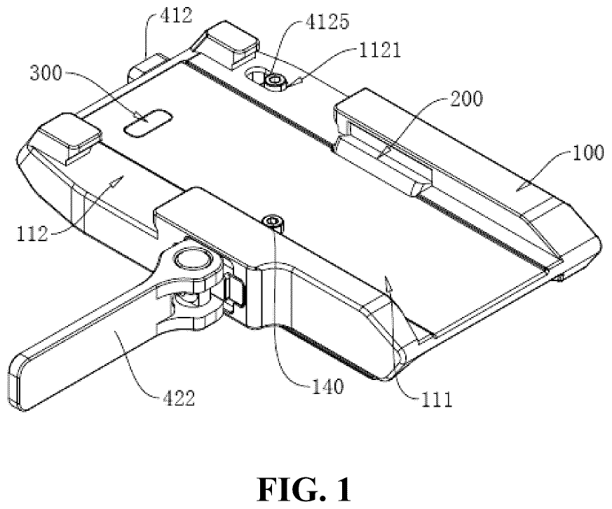

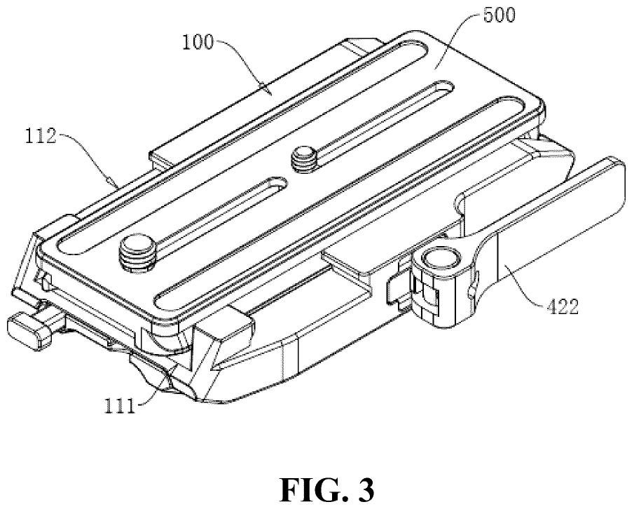

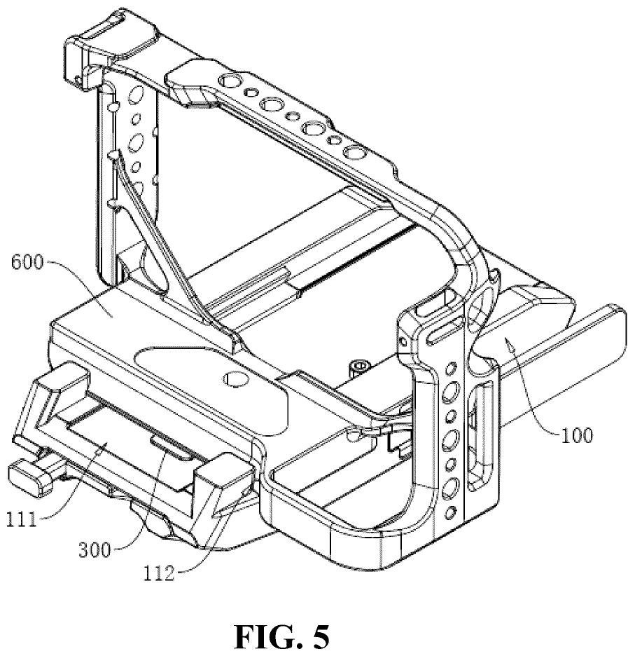

Referring to FIGS. 1-12, aspects of the disclosure provide a quick-release plate mounting base that includes a base body 100, a first locking member 200, a second locking member 300, and a driving mechanism 400. The base body 100 is provided with a first clamping groove 111 and a second clamping groove 112, with an extension direction of the first clamping groove 111 intersecting an extension direction of the second clamping groove 112. For example, the first clamping groove 111 and the second clamping groove 112 are orthogonal to each other. The first clamping groove 111 is configured for installing a first type of quick-release plate 500, and the second clamping groove 112 is configured for installing a second type of quick-release plate 600. The first locking member 200 is movably arranged on the base body 100 and has a locking state for securing the first type of quick-release plate 500 within the first clamping groove 111 and an unlocking state for releasing the first type of quick-release plate 500. The second locking member 300 is movably arranged on the base body 100 and has a locking state for securing the second type of quick-release plate 600 within the second clamping groove 112 and an unlocking state for releasing the second type of quick-release plate 600. The driving mechanism 400 is movably arranged on the base body 100 and is connected to the first locking member 200 and the second locking member 300. It is used to drive the first locking member 200 and the second locking member 300 to switch between their corresponding locking and unlocking states. For example, the driving mechanism 400 can be located on a side of the base body 100.

By operating the driving mechanism 400 to drive the first locking member 200 and the second locking member 300 to switch to the locking state, the first type of quick-release plate 500 installed in the first clamping groove 111 or the second type of quick-release plate 600 installed in the second clamping groove 112 can be secured. This endows the mounting base with the capability of installing two types of quick-release plates simultaneously, facilitating practical use.

The base body 100 can be understood as the fundamental component of the quick-release plate mounting base, with all other components of the mounting base being installed on it. In some aspects, referring to FIGS. 1-6, the base body 100 is a housing structure with a length direction, specifically including an upper housing 110 and a lower housing 120 that are assembled together. The first clamping groove 111 and the second clamping groove 112 are formed on the upper housing 110. The first clamping groove 111 extends along the length direction of the base body 100, and the second clamping groove 112 extends along the width direction of the base body 100. An installation cavity is formed between the upper housing 110 and the lower housing 120 to accommodate the installation of the first locking member 200, the second locking member 300, and the driving mechanism 400. In other aspects, the first clamping groove 111 and the second clamping groove 112 can also be oriented in other directions, and the included angle between the first clamping groove 111 and the second clamping groove 112 can also be less than 90°.

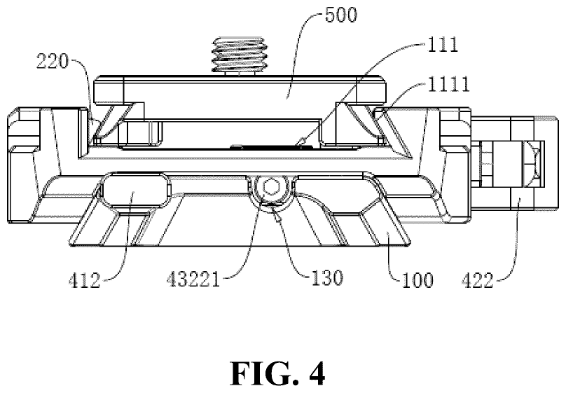

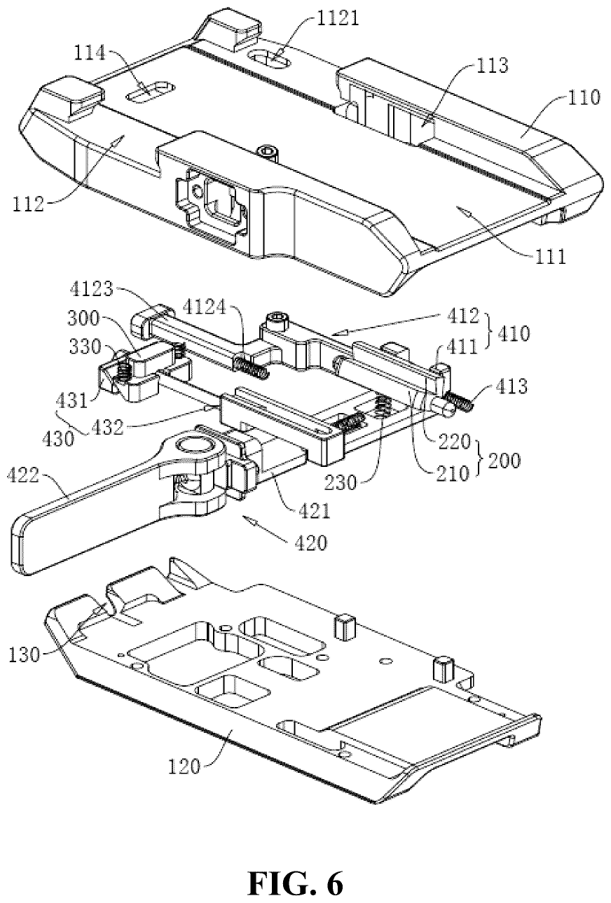

In some aspects, referring to FIGS. 4 and 6, the base body 100 is provided with a clamping member 1111. The clamping member 1111 and the first locking member 200 are respectively positioned on opposite sides of the extension direction of the first clamping groove 111. The clamping member 1111 cooperates with the first locking member 200 in the locking state to secure the first type of quick-release plate 500 within the first clamping groove 111.

Exemplarily, referring to FIGS. 1, 2, and 6, a first mounting opening 113 is provided on the base body 100. The first mounting opening 113 is located on one side of the first clamping groove 111, with a part of it being formed on the bottom wall of the first clamping groove 111 and the other part on the side wall of the first clamping groove 111. The first mounting opening 113 communicates with the installation cavity of the base body 100. The first locking member 200 is rotatably arranged in the first mounting opening 113, with its rotation axis set along the extension direction of the first clamping groove 111. The first locking member 200 has a pressing part 210 that can be exposed on the bottom wall of the first clamping groove 111 and a clamping part 220 that is integrally connected with the pressing part 210 and forms an acute angle with it. The pressing part 210 is for the first type of quick-release plate 500 to press down on so as to drive the first locking member 200 to rotate to the locking state, and the clamping part 220 can secure the first type of quick-release plate 500 in the first clamping groove 111. Referring to FIG. 4, the side wall of the first clamping groove 111 far from the first locking member 200, which is located on the opposite side wall of the first clamping groove 111, has an inclined surface, which can be referred to as the clamping member 1111. The clamping member 1111 and the clamping part 220 can form a dovetail groove structure that is adapted to the structure of the first type of quick-release plate 500, allowing the first type of quick-release plate 500 to be clamped in the first clamping groove 111.

When installing the first type of quick-release plate 500, one side of the first type of quick-release plate 500 is inserted between the clamping member 1111 and the bottom wall of the first clamping groove 111. Subsequently, the opposite side of the first type of quick-release plate 500 is pressed down. During this pressing process, the first type of quick-release plate 500 engages the pressing part 210, causing the entire first locking member 200 to pivot. When the clamping part 220 pivots to press against the first type of quick-release plate 500, the first locking member 200 and the clamping member 1111 work in tandem to secure the first type of quick-release plate 500 in position.

In some aspects, as illustrated in FIG. 6, a first spring 230 is positioned between the first locking member 200 and the base body 100, providing an elastic connection (e.g., spring-loaded connection) between them. The first spring 230 exerts an elastic force (e.g., preload force) on the first locking member 200, urging it towards the unlocking state. The presence of the first spring 230 ensures that the first locking member 200 is in the unlocking state prior to installing the first type of quick-release plate 500, thereby obviating the need for additional adjustments and facilitating direct installation of the first type of quick-release plate 500. As an example, the first spring 230 is disposed between the bottom wall of the installation cavity and the pressing part 210, and it is a compression spring.

In some aspects, referring to FIGS. 1-5, the second clamping groove 112 is a dovetail groove, and its cross-sectional shape conforms to that of the second type of quick-release plate 600, enabling the second type of quick-release plate 600 to be inserted into the second clamping groove 112 along its extension direction. The second locking member 300 is movably embedded within the base body 100 and has a locking state, in which it extends into the second clamping groove 112 and tightens against the second type of quick-release plate 600, as well as an unlocking state, in which it retracts in the opposite direction to release the second type of quick-release plate 600. The driving mechanism 400 is employed to actuate the vertical movement of the second locking member 300 between the locking state and unlocking state.

For the second locking member 300, as an example, referring to FIGS. 1, 6, and 7, a second mounting opening 114 is provided on the base body 100, corresponding to the second clamping groove 112. The second mounting opening 114 communicates with the installation cavity. The second locking member 300 includes a locking main body part 310 and a locking lifting part 320. The locking main body part 310 (e.g., a sliding lock body) is slidably inserted into the second mounting opening 114, and the locking lifting part 320 is positioned at one end of the locking main body part 310 within the installation cavity. A stepped structure can be formed between the locking lifting part 320 and the locking main body part 310 to prevent disengagement.

In some aspects, the second locking member 300 is elastically mounted on the base body 100. As an example, referring to FIG. 6, a second spring 330 is positioned between the locking lifting part 320 and the wall of the upper housing 110. The second spring 330 is oriented perpendicular to the extension directions of the first clamping groove 111 and the second clamping groove 112, and the second spring 330 can be a compression spring. The second spring 330 applies a force (e.g., preload) to the second locking member 300, urging it towards the unlocking state. In other aspects, the second spring 330 may also be positioned between the locking lifting part 320 and the wall of the lower housing 120, provided it is a tension spring.

In some aspects, as illustrated in FIG. 6, the driving mechanism 400 includes an engagement component 410, a locking component 420, and a transmission component 430, which are movably mounted on the base body 100. The transmission component 430 is in transmission connection with the locking component 420. The locking component 420 can drive the engagement component 410 to press the first locking member 200 into the locking state and can also drive the transmission component 430 to switch the second locking member 300 into the locking state. This configuration allows for the simultaneous locking of both the first locking member 200 and the second locking member 300 by operating the locking component 420, thereby enhancing user convenience.

In some aspects, referring to FIGS. 6-8, the engagement component 410 includes a resisting member 411 and an unlocking member 412. The resisting member 411 is elastically mounted on the base body 100. The first locking member 200 is equipped with a limiting protrusion 221. The resisting member 411 includes a resisting part 4111 and a groove 4112. The unlocking member 412 is movably mounted on the base body 100 and can trigger the movement of the resisting member 411 to switch the limiting protrusion 221 between pressing against the resisting part 4111 and accommodating in the groove 4112.

As an example, referring to FIGS. 6-8, the limiting protrusion 221 is located on the side of the clamping part 220 facing away from the pressing part 210 and serves as a point of contact for the resisting part 4111. The resisting member 411 includes a sliding part 4113, a resisting part 4111, and limiting parts 4114. The sliding part 4113 is slidably installed in the installation cavity, with its sliding direction extending along the first clamping groove 111. The resisting part 4111 is positioned on the side of the sliding part 4113 closer to the first locking member 200. Two limiting parts 4114 are provided, both on the sliding part 4113, one on each side of the resisting part 4111. The ends of the two limiting parts 4114 away from the sliding part 4113 extend beyond the resisting part 4111. A gap is provided between the resisting part 4111 and the sliding part 4113, serving as the groove 4112 for the limiting protrusion 221 to pivot.

When the resisting member 411 slides to a position where the resisting part 4111 opposes the limiting protrusion 221, the resisting part 4111 obstructs the rotational unlocking path of the first locking member 200, thereby retaining the first type of quick-release plate 500 within the first clamping groove 111 along its depth direction. When the resisting member 411 slides to a position where the limiting protrusion 221 opposes the groove 4112, the resisting part 4111 moves away from the rotational unlocking path of the first locking member 200.

The presence of the limiting parts 4114 ensures that, during the sliding of the resisting member 411, the parts of the limiting parts 4114 extending beyond the resisting part 4111 are constrained by the limiting protrusion 221, allowing the resisting member 411 to only move and switch between two positions: the limiting protrusion 221 abutting against the resisting part 4111 or accommodating in the groove 4112. This enhances the operational stability of the engagement component 410.

A clamping spring 413 is positioned between the resisting member 411 and the base body 100. The clamping spring 413 is disposed in the installation cavity along the extension direction of the first clamping groove 111, on the side of the sliding part 4113 where the resisting part 4111 is located. The clamping spring 413 can be a compression spring, with one end connected to the wall of the installation cavity and the other end connected to the limiting part 4114. The presence of the clamping spring 413 allows the resisting member 411 to automatically move to the position where the resisting part 4111 opposes the limiting protrusion 221 under the action of elastic force after the first locking member 200 pivots to the locking state, with the resisting part 4111 abutting against the limiting protrusion 221 to restrict the first locking member 200. In other aspects, the clamping spring 413 may also be positioned on the side of the sliding part 4113 where the groove 4112 is located, and it can be a tension spring.

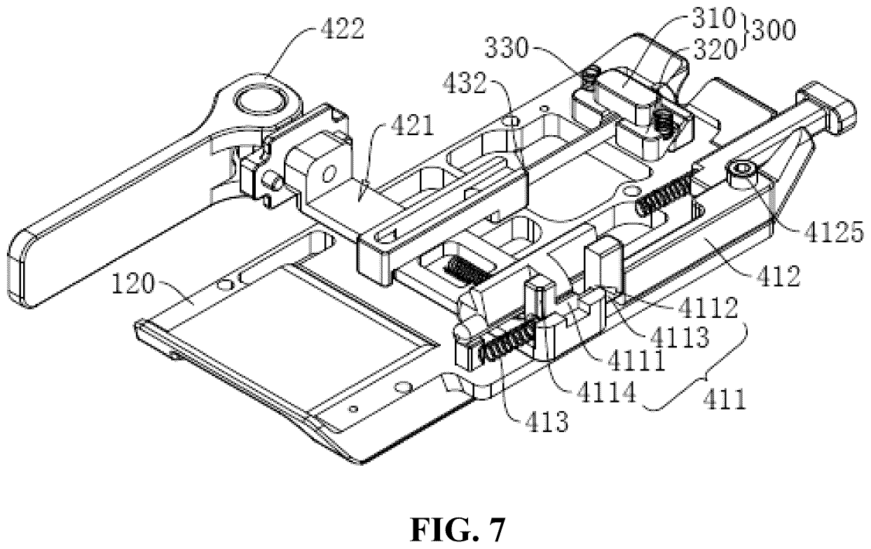

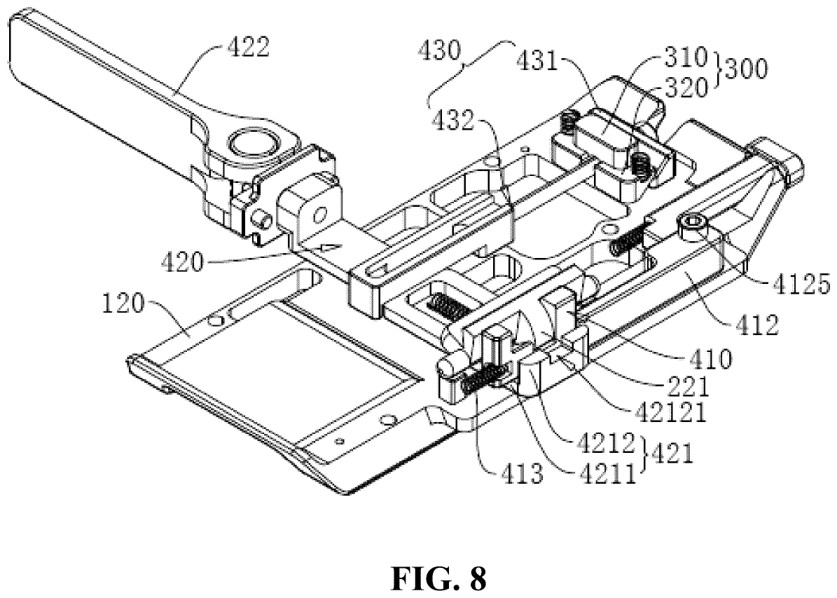

As an example, referring to FIGS. 7 and 8, the unlocking member 412 is slidably inserted into the base body 100 along the extension direction of the first clamping groove 111 and is located on the side of the resisting member 411 away from the clamping spring 413. One end of the unlocking member 412 is located in the installation cavity, and the other end extends out of the base body 100. The end of the unlocking member 412 in the installation cavity abuts against the resisting member 411. By pressing the unlocking member 412, the resisting member 411 can be moved to the position where the groove 4112 opposes the limiting protrusion 221, thereby unlocking the first locking member 200. In other aspects, the unlocking member 412 may also be fixedly connected to the resisting member 411. If the unlocking member 412 is fixedly connected to the resisting member 411, the resisting member 411 can be freely moved without relying on the clamping spring 413, allowing the limiting protrusion 221 to switch between abutting against the resisting part 4111 and accommodating in the groove 4112. Consequently, in some aspects where the unlocking member 412 is fixedly connected to the resisting member 411, the clamping spring 413 is omitted from the quick-release plate mounting base.

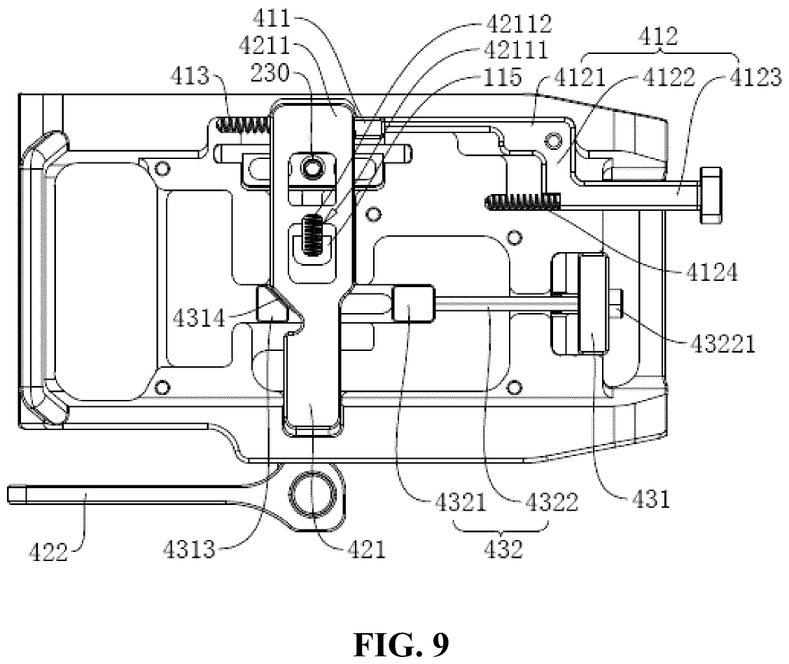

In some aspects, the unlocking member 412 may adopt an anti-disengagement design that prevents it from being easily removed from the base body 100. As an example, referring to FIG. 9, the unlocking member 412 includes a first part 4121 (e.g., a first portion), a second part 4122 (e.g., a second portion), and a third part 4123 (e.g., a third portion). Both the first part 4121 and the third part 4123 extend along the extension direction of the first clamping groove 111 and are offset from each other. The second part 4122 connects the first part 4121 and the third part 4123 and extends along the extension direction of the second clamping groove 112. The end of the first part 4121 away from the second part 4122 is used to connect or abut against the resisting member 411. The end of the third part 4123 away from the second part 4122 extends out of the base body 100 for the operator to press or operate.

Since only the end of the first part 4121 of the unlocking member 412 is subjected to the elastic force transmitted by the resisting member 411, this may result in uneven force distribution on the unlocking member 412, causing it to slide jerkily along the extension direction of the first clamping groove 111. Therefore, in a further aspect, as illustrated in FIG. 9, a first auxiliary spring 4124 may be added. The first auxiliary spring 4124 is positioned between the base body 100 and the third part 4123 to apply an elastic force (e.g., preload) to the third part 4123 in the same or a similar direction as that of the clamping spring 413. For example, the first auxiliary spring 4124 is disposed along the extension direction of the first clamping groove 111 on the side of the third part 4123 where it connects to the second part 4122. One end of the first auxiliary spring 4124 is connected to the wall of the installation cavity, while the other end is connected to the third part 4123, applying an elastic force to the third part 4123 along the extension direction of the first clamping groove 111, facilitating its extension out of the base body 100.

In some aspects, with reference to FIGS. 7 and 8, the locking component 420 includes a locking actuator 421 and a locking operator 422. The locking actuator 421 is movably mounted on the base body 100 and includes a locking part 4212 (e.g., locking portion). The locking part 4212 is positioned on the side of the resisting member 411 opposite to the first locking member 200. The locking operator 422 is connected to the locking actuator 421 and can rotate to drive the locking actuator 421 to move, enabling the locking part 4212 to press against or separate from the resisting member 411. When the locking part 4212 presses against the resisting member 411, it causes the resisting member 411 to press tightly against the first locking member 200, thereby locking the first type of quick-release plate 500, enhancing locking security.

In one aspect, as shown in FIG. 7, the locking actuator 421 includes a locking plate 4211 and a locking part 4212. The locking plate 4211 is slidably disposed within an installation cavity, with its sliding direction extending along the extension direction of the second clamping groove 112. One end of the locking plate 4211 extends to the side of the resisting member 411 opposite to the first clamping member, and the locking part 4212 is positioned at the end of the locking plate 4211 close to the resisting member 411. The locking part 4212 can move with the locking plate 4211 to a position where it presses against the resisting member 411.

If the locking operator 422 rotates to drive the locking actuator 421 to move, causing the locking actuator 421 to press the resisting member 411 at a position where the groove 4112 is opposite the limiting protrusion 221, the first locking member 200 may still rotate, indicating that the locking actuator 421 is in an idle locking state. In this state, the first type of quick-release plate 500 can still be installed between the first locking member 200 and the clamping member 1111, but it is not tightly locked and can still slide along the extension direction of the first clamping groove 111, posing a usage risk.

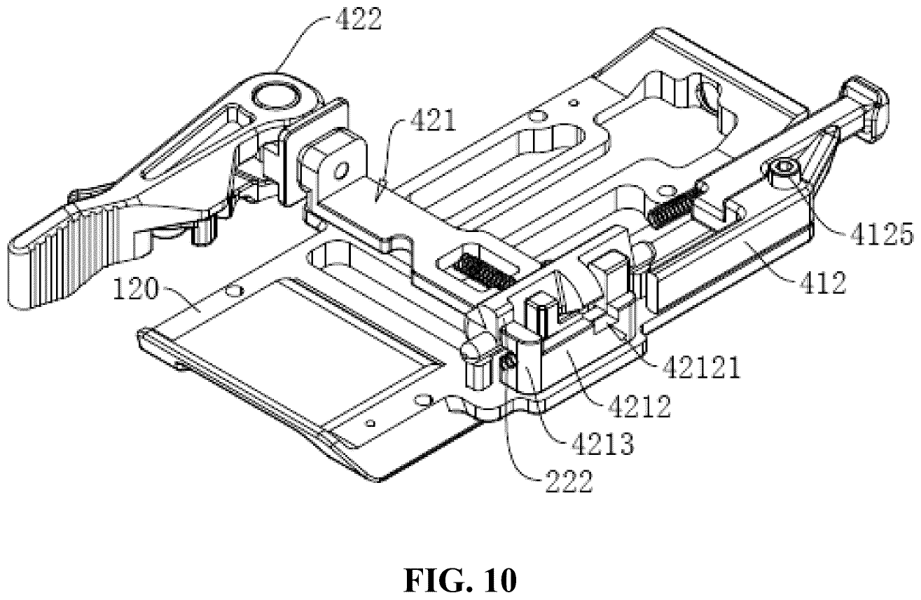

In response to this issue, in a further aspect, as depicted in FIG. 10, the locking part 4212 further includes a protruding block 4213. The locking operator 422 can rotate to drive the locking actuator 421 to move, allowing the protruding block 4213 to abut against the first locking member 200. For instance, the protruding block 4213 is positioned at one end of the locking part 4212 and protrudes toward the first locking member 200 beyond the locking part 4212. When the locking part 4212 presses against the resisting member 411, the protruding block 4213 presses against the clamping part 220, causing the side of the clamping part 220 opposite to the protruding block 4213 to extend out of the first mounting opening 113, thereby preventing the installation of the first type of quick-release plate 500 and avoiding the idle locking state. In some cases, the protruding block 4213 is equipped with a relief groove for the clamping spring to pass through. In some instances, a boss 222 corresponding to the protruding block 4213 may be provided on the first locking member 200 for the protruding block 4213 to press against and drive the rotation of the first locking member 200.

In some aspects, as illustrated in FIGS. 9 and 10, an avoiding groove 42121 (e.g., a cutout) corresponding to the limiting protrusion 221 may also be provided on the locking part 4212 to prevent interference with the rotation of the limiting protrusion 221 by the locking part 4212.

In one aspect, as shown in FIGS. 7-10, the locking operator 422 can be a locking wrench with an eccentric structure. For example, the locking wrench is mounted on the side of the base body 100 opposite to the first locking member 200. The rotating shaft of the locking wrench is fixedly connected to the end of the locking plate 4211 opposite to the locking part 4212. The rotating shaft of the locking wrench is eccentrically mounted, so that when the locking wrench is turned, it drives the rotating shaft to move, which in turn causes the locking plate 4211 to slide, resulting in the locking part 4212 pressing against or separating from the resisting member 411, enabling locking or unlocking. In some aspects, the locking operator may be a locking wrench with a limiting lock to secure the position of the locking wrench.

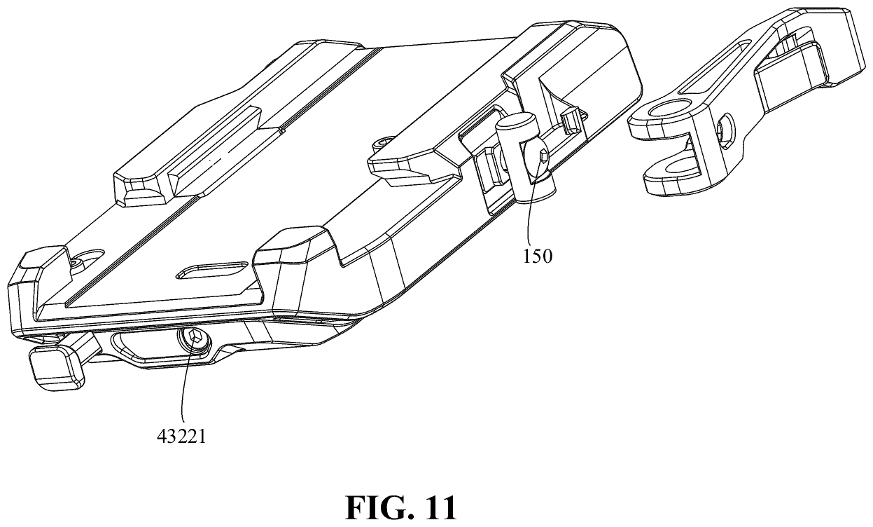

In some further aspects, as depicted in FIG. 11, the mounting base further includes an adjusting screw 150. The locking operator 422 (e.g., locking wrench) is connected to the locking plate 4211 via the adjusting screw 150. The adjusting screw 150 can be rotated using auxiliary tools (such as a screwdriver) to adjust the locking force exerted by the locking operator 422.

Additionally, in some further aspects, referring to FIGS. 7-9, a second auxiliary spring 42112 can be disposed between the locking actuator 421 and the base body 100. The second auxiliary spring 42112 applies an elastic force (e.g., preload) to the locking actuator 421, urging it to move away from the locking operator 422. For example, the middle part of the locking plate 4211 is provided with an avoiding cavity 42111 (e.g., a cutoff). The upper housing 110 is equipped with a fixed protrusion 115 that extends into the avoiding cavity 42111. The second auxiliary spring 42112 is installed in the avoiding cavity 42111, extending along the extension direction of the second clamping groove 112. One end of the second auxiliary spring 42112, farther from the locking operator 422, abuts against the wall of the avoiding cavity 42111, while the other end abuts against the fixed protrusion 115. The second spring 330 is a compression spring.

In other aspects, the locking component 420 may also include a tightening bolt. The tightening bolt is positioned on one side of the base body 100 opposite to the clamping part 220. The first locking member 200 can also be tightly locked by adjusting the tightening bolt. In summary, whether utilizing the locking actuator 421 and the locking operator 422, or employing a tightening bolt or other components, any structure capable of meeting the design and usage requirements for tightly locking the first locking member 200 is acceptable.

In one aspect, referring to FIGS. 7-9, the transmission component 430 includes a locking trigger 431 and a linkage member 432. The linkage member 432 is interconnected between the locking component 420 and the locking trigger 431. The movement of the locking component 420 drives the linkage member 432 to move, causing the locking trigger 431 to press the second locking member 300 into a locking state.

In one aspect, referring to FIGS. 8, 9, and 12, the locking trigger 431 features a trigger inclined surface. The locking trigger pushes the second locking member via the trigger inclined surface to switch the second locking member between an unlocking state and a locking state.

For instance, the locking trigger 431 is slidably disposed within an installation cavity provided in the base body 100 and is located on one side of the second locking member 300. The sliding direction of the locking trigger 431 extends along the extension direction of the first clamping groove 111. The side of the locking trigger 431 close to the second locking member 300 has a trigger inclined surface 4311. The locking trigger 431 contacts the second locking member 300 through the trigger inclined surface 4311, so that when the locking trigger 431 slides closer to the second locking member 300, it can push the second locking member 300 to ascend, and when it slides away from the second locking member 300, the second locking member 300 can descend.

In a further aspect, referring to FIGS. 8, 9, and 12, the second locking member 300 features a pushed inclined surface. The locking trigger presses against the pushed inclined surface to drive the second locking member to switch between an unlocking state and a locking state.

For example, a pushed inclined surface 321 is provided on the side of the second locking member 300 that is adjacent to the locking trigger 431. This pushed inclined surface 321 is parallel to and faces the trigger inclined surface 4311. The locking trigger 431 presses against the pushed inclined surface 321 via the trigger inclined surface 4311, thereby driving the second locking member 300 to ascend.

In other aspects, it is also feasible to provide only a pushed inclined surface 321 on the second locking member 300 to elevate the second locking member 300 through the movement of the locking trigger 431 along the extension direction of the first clamping groove 111.

In one aspect, with reference to FIGS. 7, 8, and 12, the linkage member 432 includes a linkage part 4321 (e.g., a linkage portion) and a linkage rod 4322. The linkage part 4321 is slidably disposed within the base body 100 and is interconnected with the locking component 420. One end of the linkage rod 4322 is connected to the linkage part 4321, while the other end is in transmission connection with the locking trigger 431.

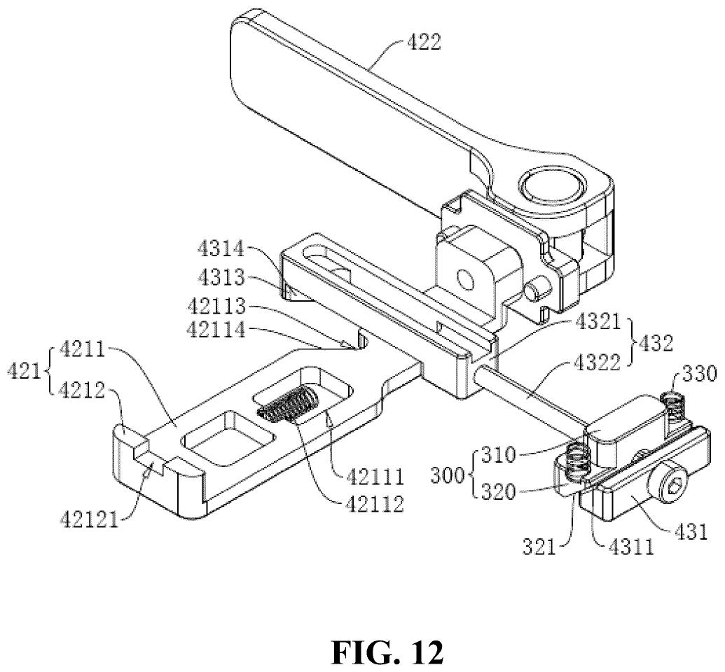

In one aspect, with reference to FIGS. 8 and 12, the linkage part 4321 is equipped with a fitting protrusion 4313, which has a first driving inclined surface 4314. The locking component 420 includes a fitting cavity 42113 designed to receive the fitting protrusion 4313. The wall on one side of the fitting cavity 42113 is provided with a second driving inclined surface 42114, which is configured to abut against the first driving inclined surface 4314 and transmit a force thereto.

For instance, with reference to FIGS. 9 and 12, the linkage part 4321 is slidably disposed within the installation cavity along the extension direction of the first clamping groove 111. One end of the linkage part 4321 extends to the side of the locking plate 4211 away from the second locking member 300. The fitting protrusion 4313 is located at the end of the linkage part 4321 away from the second locking member 300. The cross-section of the fitting protrusion 4313 is approximately in the shape of a right-angled triangle, with its inclined surface being the first driving inclined surface 4314. The corners of the fitting protrusion 4313 are rounded. The side of the locking plate 4211 away from the second locking member 300 is provided with a fitting cavity 42113 that corresponds to the fitting protrusion 4313. The shape of the fitting cavity 42113 matches that of the fitting protrusion 4313, and the wall of the fitting cavity 42113 that is opposite to the first driving inclined surface 4314 is the second driving inclined surface 42114.

In other aspects, a protrusion with an inclined surface may also be provided on the locking actuator 421, and the movement of this protrusion can drive the linkage part 4321 to slide for interconnection.

In one aspect, with reference to FIGS. 9 and 12, one end of the linkage rod 4322 is threadedly connected to the linkage part 4321, while the other end penetrates through the locking trigger 431 along the sliding direction of the locking trigger 431. The end of the linkage rod 4322 that passes through the locking trigger 431 is provided with a limiting end 43221, which abuts against the locking trigger 431. The linkage rod 4322 facilitates the adjustment of the tightness between the second locking member 300 and the locking trigger 431, thereby adjusting the locking degree of the second locking member 300. In other aspects, both ends of the linkage rod 4322 may also be threadedly connected to the linkage part 4321 and the locking trigger 431, respectively. It is noteworthy that the linkage rod 4322 may be a screw rod, and the limiting end 43221 is the head of the screw rod. The limiting end 43221 can be adjusted using auxiliary tools to modify the structural tightness of the transmission component 430, thereby adjusting the locking force for securing the second type of quick-release plate.

In further aspects, with reference to FIGS. 4 and 6, an adjusting hole 130 is provided on the base body 100 in alignment with the linkage rod 4322. The adjusting hole 130 is used to adjust the linkage rod 4322, allowing for adjustments outside the base body 100. For instance, the adjusting hole 130 is positioned at one end of the base body 100 along the extension direction of the first clamping groove 111 and is opposite to the limiting end 43221 on the linkage rod 4322.

In one aspect, with reference to FIGS. 1, 2, and 7, the unlocking member 412 is provided with a first anti-disengagement protrusion 4125. A limiting sliding groove 1121 is arranged on the bottom wall of the second clamping groove 112 along the movement direction of the resisting member 411. The first anti-disengagement protrusion 4125 protrudes from the limiting sliding groove 1121. When the resisting part 4111 of the resisting member 411 moves to a position opposite to the limiting protrusion 221, the first anti-disengagement protrusion 4125 is in an anti-disengagement position. A disengagement-preventing notch is provided on the bottom surface of the second type of quick-release plate 600. The first anti-disengagement protrusion 4125 can move into the disengagement-preventing notch of the second type of quick-release plate 600, such that the first anti-disengagement protrusion 4125 in the anti-disengagement position can prevent the second type of quick-release plate 600 from disengaging from the second clamping groove 112 along its extension direction. In this manner, whether disassembling the first type of quick-release plate 500 or the second type of quick-release plate 600, the disassembling steps involve first operating the locking operator 422 to release the lock, then pressing the unlocking member 412 to cause it to drive the first anti-disengagement protrusion 4125 and the resisting member 411 to unlock, and only then can the first type of quick-release plate 500 or the second type of quick-release plate 600 be removed. This helps to standardize the operation steps and reduce the difficulty of use.

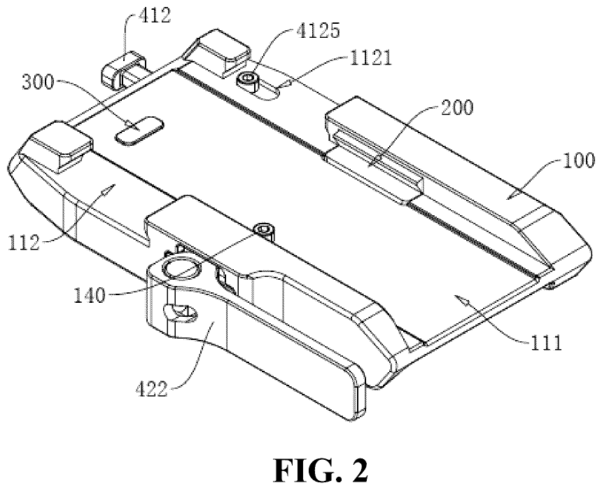

In one aspect, with reference to FIGS. 1 and 2, a second anti-disengagement protrusion 140 is also included. The second anti-disengagement protrusion 140 is arranged on the bottom wall of the first clamping groove 111. A disengagement-preventing notch is also provided on the bottom surface of the first type of quick-release plate 500. The second anti-disengagement protrusion 140 can engage within the disengagement-preventing notch of the first type of quick-release plate 500 to prevent the first type of quick-release plate 500 from disengaging from the first clamping groove 111 along its extension direction. In some aspects, the second anti-disengagement protrusion 140 may be fixedly or removably arranged on the bottom wall of the first clamping groove 111. For instance, the second anti-disengagement protrusion 140 is a bolt, and a threaded hole is opened on the bottom wall of the first clamping groove 111. The second anti-disengagement protrusion 140 is removably installed on the bottom wall of the first clamping groove 111 through the threaded hole.

In an aspect of an auxiliary photographing device 1000, the auxiliary photographing device 1000 includes a tripod main body 700 and a quick-release plate mounting base installed on the tripod main body 700, where the quick-release plate mounting base includes the quick-release plate mounting base according to any of the aforementioned aspects.

The above description uses specific examples to elaborate on the present disclosure, which is solely for the purpose of aiding understanding and is not intended to limit the present disclosure. For those skilled in the technical field to which the present disclosure belongs, based on the idea of the present disclosure, several simple deductions, deformations, or substitutions can also be made.

What is claimed is:

1. A quick-release plate mounting base, comprising:
a base body with a first clamping groove and a second clamping groove, wherein the first clamping groove is configured for accommodating a first type of quick-release plate, and the second clamping groove is configured for accommodating a second type of quick-release plate;
a first locking member, movably provided on the base body, the first locking member configured to secure the first type of quick-release plate within the first clamping groove in a first locking state, and to release the first type of quick-release plate in a first unlocking state;
a second locking member, movably provided on the base body, the second locking member configured to secure the second type of quick-release plate within the second clamping groove in a second locking state, and to release the second type of quick-release plate in a second unlocking state; and
a driving mechanism that is movably provided on the base body and cooperates with both the first locking member and the second locking member, enabling the first locking member to transition between the first locking state and the first unlocking state, and the second locking member to transition between the second locking state and the second unlocking state.

2. The quick-release plate mounting base according to claim 1, wherein an extension direction of the first clamping groove intersects with an extension direction of the second clamping groove.

3. The quick-release plate mounting base according to claim 1, wherein the driving mechanism comprises an engagement component, a locking component, and a transmission component, and the engagement component, the locking component, and the transmission component are all movably provided on the base body;
wherein the locking component is in driving connection with the transmission component; and
wherein the locking component is configured to drive the engagement component to transition the first locking member to the locking state and is configured to concurrently drive the transmission component to transition the second locking member to the locking state.

4. The quick-release plate mounting base according to claim 3, wherein the engagement component comprises a resisting member and an unlocking member;
wherein the resisting member is elastically mounted on the base body;
wherein the first locking member is provided with a limiting protrusion, and the resisting member comprises a resisting part and a groove; and
wherein the unlocking member is movably provided on the base body and is configured to move the resisting member, enabling the limiting protrusion to transition between abutting against the resisting part and accommodating in the groove.

5. The quick-release plate mounting base according to claim 4, wherein the locking component comprises a locking actuator and a locking operator;
wherein the locking actuator is movably provided on the base body and is provided with a locking part located on one side of the resisting member away from the first locking member; and
wherein the locking operator is connected to the locking actuator; in response to an actuation of the locking operator, the locking actuator is configured to drive the locking part to press against or separate from the resisting member.

6. The quick-release plate mounting base according to claim 5, wherein the locking part further comprises a protruding block; and
in response to an actuation of the locking operator, the locking actuator is configured to drive the protruding block to abut against the first locking member.

7. The quick-release plate mounting base according to claim 3, wherein the transmission component comprises a locking trigger and a linkage member;
wherein the linkage member cooperates with the locking component; and
wherein the locking component is configured to move the linkage member, enabling the locking trigger to drive the second locking member to transition between the unlocked state and the locking state.

8. The quick-release plate mounting base according to claim 7, wherein the locking trigger comprises a trigger inclined surface, and the locking trigger is configured to move the second locking member through the trigger inclined surface to transition between the unlocked state and the locking state.

9. The quick-release plate mounting base according to claim 8, wherein the second locking member comprises a pushed inclined surface,
in response to an actuation of the locking trigger, the trigger inclined surface presses against the pushed inclined surface to drive the second locking member to transition between the unlocked state and the locking state.

10. The quick-release plate mounting base according to claim 7, wherein the linkage member comprises a linkage part and a linkage rod;
wherein the linkage part is movably provided in the base body and cooperates with the locking component; and
wherein a first end of the linkage rod is connected to the linkage part, and a second end of the linkage rod is in transmission connection with the locking trigger.

11. The quick-release plate mounting base according to claim 10, wherein the linkage part is provided with a fitting protrusion comprising a first driving inclined surface;
wherein the locking component is provided with a fitting cavity configured to accommodate the fitting protrusion; and
wherein a wall on one side of the fitting cavity is provided with a second driving inclined surface, and the second driving inclined surface is configured to abut against the first driving inclined surface to transmit a force to the first driving inclined surface.

12. The quick-release plate mounting base according to claim 3, wherein the base body is provided with a clamping member disposed opposite to the first locking member respectively on both sides along an extending direction of the first clamping groove;
wherein the clamping member cooperates with the first locking member in a locking state to secure a first type of quick-release plate within the first clamping groove;
wherein the first locking member is rotatably provided on the base body, with a rotation axis along the extending direction of the first clamping groove;
wherein the first locking member comprises a pressing part being exposed on a bottom wall of the first clamping groove and a clamping part connected to the pressing part; and
wherein the first type of quick-release plate is configured to press the pressing part to drive the first locking member to rotate to a locking state, and the clamping part is configured to lock the first type of quick-release plate in the first clamping groove.

13. The quick-release plate mounting base according to claim 3, wherein the second clamping groove comprises a dovetail groove;
wherein the second locking member is movably provided in the base body and is configurable in a locking state for extending into the second clamping groove and tightening against the second type of quick-release plate, and an unlocking state for retracting in an opposite direction to release the second type of quick-release plate; and
wherein the locking component is configured to drive the second locking member between a lift position or a lower position through the transmission component.

14. The quick-release plate mounting base according to claim 4, wherein the unlocking member is provided with a first anti-disengagement protrusion;
wherein a limiting sliding groove is provided on a bottom wall of the second clamping groove along a moving direction of the resisting member;
wherein the first anti-disengagement protrusion protrudes from the limiting sliding groove;
wherein in response to the resisting member being in a position placing the resisting part opposite to the limiting protrusion, the first anti-disengagement protrusion is located at an anti-disengagement position; and
wherein the first anti-disengagement protrusion at the anti-disengagement position restricts the second type of quick-release plate from disengaging from the second clamping groove along an extending direction of the second clamping groove.

15. An auxiliary shooting device, comprising a tripod main body and a quick-release plate mounting base installed on the tripod main body; and
wherein the quick-release plate mounting base comprises the quick-release plate mounting base according to claim 1.
